(19) United States
(12) Patent Application Publication
(10) Pub. No.: US 2020/0007063 A1
(43) Pub. Date: Jan. 2, 2020

(54) MOTOR CONTROLLING METHOD, MOTOR CONTROLLING SYSTEM, AND ELECTRONIC POWER STEERING SYSTEM

(71) Applicant: Nidec Corporation, Kyoto (JP)

(72) Inventor: Ahmad GHADERI, Kyoto (JP)

(21) Appl. No.: 16/484,931

(22) PCT Filed: Jan. 10, 2018
(86) PCT No.: PCT/JP2018/000248

§ 371 Date: Aug. 9, 2019

(30) Foreign Application Priority Data
Mar. 3, 2017 (JP) 2017-040908

(51) Int. Cl. H02P 21/20; H02P 21/09; H02P 21/22; B62D 5/04

(52) U.S. Cl. CPC H02P 21/20; H02P 21/09; B62D 3/12; B62D 5/0421; H02P 2207/055; H02P 21/22

(57) ABSTRACT

A motor controlling method includes a step of obtaining a resultant magnetic flux and a stator current, which are represented by a phasor, with respect to an αβ fixed coordinate system or a dq rotating coordinate system, a step of calculating a torque angle (δ) according to:

δ=cos⁻¹[(ψₛ²+ψₘ²−(LIₛ)²)/(2ψₛψₘ)],

where L is an armature inductance, ψₘ indicates a magnetic flux of a stator magnet, ψₛ indicates a magnitude of the resultant magnetic flux, and Iₛ indicates a magnitude of the stator current, and a step of controlling the surface permanent magnet motor based on the torque angle (δ).

### CROSS REFERENCE TO RELATED APPLICATIONS

This is a U.S. national stage of PCT Application No. PCT/JP2018/000248, filed on Jan. 10, 2018, and priority under 35 U.S.C. § 119(a) and 35 U.S.C. § 365(b) is claimed from Japanese Application No. 2017-040908, filed Mar. 3, 2017; the entire disclosures of which are incorporated herein by reference.

### FIELD OF THE INVENTION

The present disclosure relates to a motor controlling method, a motor controlling system, and an electronic power steering system.

### BACKGROUND

Recently, an electric driving system has been widely used in various applications. An example of the electric driving system may include a motor controlling system. The motor controlling system controls, for example, an electric motor (hereinafter, referred to as a “motor”) using a vector control. The vector control includes, for example, a method using a current sensor and a position sensor (hereinafter, referred to as a “sensor control”) and a method using only a current sensor (hereinafter, referred to as a “sensorless control”). In the sensor control, a rotor position (hereinafter, referred to as a “rotor angle”) is calculated based on a measured value of the position sensor. On the other hand, in the sensorless control, a rotor angle is estimated based on a current or the like measured by the current sensor.

Generally, torque information is required for the vector control. For example, torque may be calculated based on a torque angle of the motor. In particular, in the sensorless control, it is required to estimate a rotor angle based on a torque angle. As described above, it is important to precisely obtain the torque angle so as to improve precision of the vector control. For example, it is known that the torque angle in the sensor control may be calculated using a variable in a dq rotating coordinate system. The torque angle is also referred to as a load angle.

A related art discloses a sensorless control for estimating a torque angle using a so-called observer. Specifically, the observer estimates a rotor angle based on a current value measured by a current sensor and also estimates feedback⋅torque angle based on the estimated rotor angle. Another related art discloses an operation Equation for obtaining a torque angle based on an estimated value of torque.

There is a case in which a calculation of a torque angle based on variables in a dq rotational coordinate system used for a sensor control is not applicable to a sensorless control. The reason is as follows. The dq rotating coordinate system is a rotating coordinate system that rotates together with a rotor and is a coordinate system that is set based on a rotor angle and a rotational speed. On the other hand, in the sensorless control, there is a case in which a torque angle is required for estimating a rotor angle. In this case, in the sensorless control, there is a need for a method of calculating a torque angle which does not depend on variables in the dq rotating coordinate system.

A sensorless control for estimating a torque angle using an observer disclosed in the related art usually requires various parameters (for example, armature inductance and reactance) with respect to a motor and is strongly influenced by the parameters. For example, in the related art, it is described that the estimation using the observer strongly depends on an initial value and a noise covariance matrix particularly. As a result, when the value and matrix are incorrectly selected, a motor is likely to be unstably controlled. In addition, the estimation by the observer requires a more complicated calculation. Therefore, there is a problem in that a calculation load of a computer is increased. For this reason, there is a need for a method for estimating a torque angle which does not particularly require a complicated calculation in the sensorless control.

### SUMMARY

A motor controlling method according to an example embodiment of the present disclosure is a method of controlling a surface permanent magnet motor, the motor controlling method including a step of obtaining a resultant magnetic flux and a stator current, which are represented by a phasor, with respect to an αβ fixed coordinate system or a dq rotating coordinate system, a step of calculating a torque angle (δ) according to:

δ=cos⁻¹[(ψₛ²+ψₘ²−(LIₛ)²)/(2ψₐψₘ)],

where L is an armature inductance, ψₘ indicates a magnetic flux of a stator magnet, ψₛ indicates a magnitude of the resultant magnetic flux, and Iₛ indicates a magnitude of the stator current, and a step of controlling the surface permanent magnet motor based on the torque angle (δ).

A motor controlling system according to an example embodiment of the present disclosure includes a surface permanent magnet motor and a control circuit to control the surface permanent magnet motor, wherein the control circuit obtains a stator current and a stator voltage, which are represented by a phasor, with respect to an αβ fixed coordinate or a dq rotating coordinate system, calculates a torque angle (δ) according to:

δ=cos⁻¹[(ψₛ²+ψₘ²−(LIₛ)²)/(2ψₓψₘ)],

where L is an armature inductance, ψₘ indicates a magnetic flux of a stator magnet, ψₛ indicates a magnitude of the resultant magnetic flux, and Iₛ indicates a magnitude of the stator current, and controls the surface permanent magnet motor based on the torque angle (δ).

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a block diagram illustrating a hardware block of a motor controlling system according to an example embodiment of the present disclosure.

FIG. 2 is a block diagram illustrating a hardware configuration of an inverter 300 of the motor controlling system according to an example embodiment of the present disclosure.

FIG. 3 is a block diagram illustrating a hardware block of a motor controlling system according to a modified example of an example embodiment of the present disclosure.

FIG. 4 is a functional block diagram illustrating a functional block of a controller.

FIG. 5 is a phasor diagram showing variables (Iₛ, ψₛ, ϕ, and Vₛ).

FIG. 6 is a phasor diagram showing a resultant magnetic flux (ψₛ) on anαβ fixed coordinate system or dq rotating coordinate system.

FIG. 7 is a phasor diagram showing a rotor magnetic flux (ψₘ), an armature magnetic flux (ψₐ), and a resultant magnetic flux (ψₛ).

FIG. 8 is a graph showing a waveform of torque (top), waveforms of three-phase currents (middle), and waveforms of three-phase voltages (bottom) within a certain period.

FIG. 9 is a graph showing a waveform of a torque angle (degree) estimated using an equation according to an example embodiment of the present disclosure and a measured value of a torque angle within a certain period.

FIG. 10 is a schematic diagram illustrating a typical configuration of an electric power steering (EPS) system according to an example embodiment of the present disclosure.

### DETAILED DESCRIPTION

Hereinafter, example embodiments of motor controlling methods, motor controlling systems, and electronic power steering systems each including a motor controlling system according to an example embodiment of the present disclosure will be described with reference to the accompanying drawings. However, there will be instances in which unnecessarily detailed description is omitted. This is to prevent the following description from being unnecessarily lengthy, in order to facilitate understanding for a person of ordinary skill in the art. For example, detailed descriptions of subject matter that is already well-known, as well as a redundant description of components that are substantially the same will be omitted in some cases.

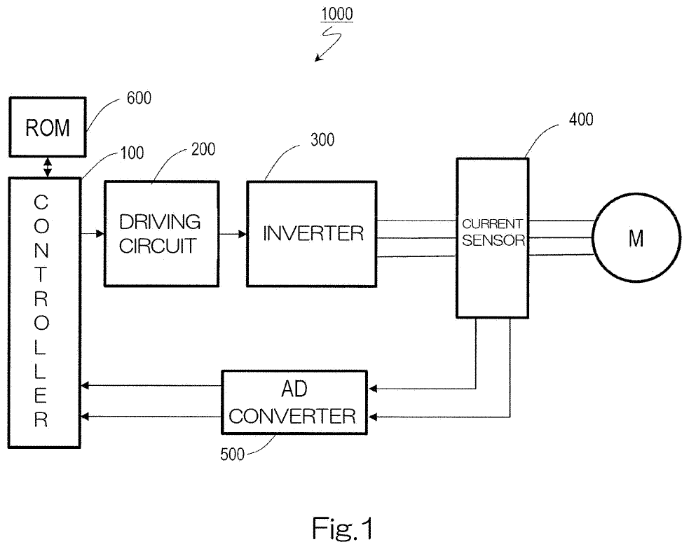

FIG. 1 schematically shows a hardware block of a motor controlling system 1000 according to the present example embodiment.

The motor controlling system 1000 typically includes a motor M, a controller (control circuit) 100, a driving circuit 200, an inverter (also referred to as an “inverter circuit”) 300, a plurality of current sensors 400, an analog-to-digital conversion circuit (hereinafter, referred to as an “AD converter”) 500, and a read only memory (ROM) 600. The motor controlling system 1000 may be modularized. Thus, for example, the motor controlling system 1000 may be manufactured and sold as a motor module including a motor, a sensor, a driver, and a controller. In the present specification, the motor controlling system 1000 will be described by exemplifying a system having the motor M as a component. However, the motor controlling system 1000 may be a system for driving the motor M which does not include the motor M as a component.

The motor M is a surface permanent magnet (SPM) motor, for example, a surface permanent magnet synchronous motor (SPMSM). The motor M includes three-phase coils (U-phase coil, V-phase coil, and W-phase coil) (not shown). The three-phase coils are electrically connected to the inverter 300. The present disclosure is not limited to a three-phase motor, but multiphase motors such as a five-phase motor and a seven-phase motor are also within the scope of the present disclosure. In the present specification, example embodiments of the present disclosure will be described by exemplifying a motor controlling system for controlling a three-phase motor.

The controller 100 is, for example, a microcontroller unit (MCU). Alternatively, the controller 100 may also be implemented, for example, as a field programmable gate array (FPGA) equipped with a central processing unit (CPU) core.

The controller 100 controls the entirety of the motor controlling system 1000 and controls, for example, torque and a rotational speed of the motor M through a vector control. The present disclosure is not limited to the vector control, and the motor M may also be controlled though other closed loop controls. The rotational speed is expressed in revolutions per minute (rpm) at which a rotor rotates for a unit time (for example, for one minute) or revolutions per second (rps) at which the rotor rotates for a unit time (for example, for one second). The vector control is a method of dividing a current flowing in a motor into a current component contributing to the generation of torque and a current component contributing to the generation of a magnetic flux and independently controlling the current components orthogonal to each other. The controller 100 sets, for example, a target current value according to an actual current value measured by the plurality of current sensors 400 and a rotor angle estimated based on the actual current value. The controller 100 generates a pulse width modulation (PWM) signal based on the target current value and outputs the generated PWM signal to the driving circuit 200.

The driving circuit 200 is, for example, a gate driver. The driving circuit 200 generates a control signal for controlling a switching operation of a switching element in the inverter 300 according to the PWM signal output from the controller 100. As will be described below, the driving circuit 200 may be mounted on the controller 100.

For example, the inverter 300 converts direct current (DC) power supplied from a DC power source (not shown) into alternating current (AC) power and drives the motor M with the converted AC power. For example, the inverter 300 converts DC power into three-phase AC power which is a pseudo-sinusoidal wave having a U-phase, a V-phase, and a W-phase based on a control signal output from the driving circuit 200. The motor M is driven by the converted three-phase AC power.

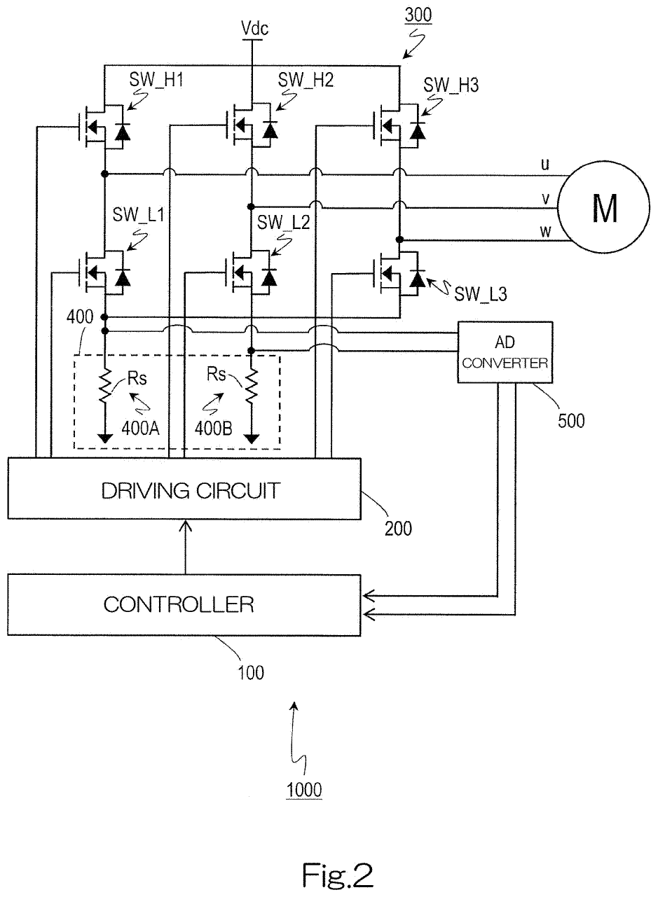

The plurality of current sensors 400 include at least two current sensors configured to detect at least two currents flowing in the U-phase, V-phase, and W-phase coils of the motor M. In the present example embodiment, the plurality of current sensors 400 include two current sensors 400A and 400B (see FIG. 2) configured to detect currents flowing in the U-phase and the V-phase. Of course, the plurality of current sensors 400 may include three current sensors configured to detect three currents flowing in the U-phase, the V-phase, and the W-phase coils. For example, the plurality of current sensors 400 may include two current sensors configured to detect currents flowing in the V-phase and the W-phase or currents flowing in the W-phase and the U-phase. The current sensor includes, for example, a shunt resistor and a current detection circuit (not shown) configured to detect a current flowing in the shunt resistor. A resistance value of the shunt resistor is, for example, about 0.1Ω.

The AD converter 500 samples an analog signal output from the plurality of current sensors 400, converts the analog signal into a digital signal, and outputs the converted digital signal to the controller 100. The controller 100 may also perform AD conversion. In this case, the plurality of current sensors 400 directly output an analog signal to the controller 100.

The ROM 600 is, for example, a writable memory (for example, a programmable read only memory (PROM)), a rewritable memory (for example, a flash memory), or a read-only memory. The ROM 600 stores a control program having a command group for controlling the motor M in the controller 100. For example, the control program is first loaded in a random access memory (RAM, not shown) at the time of booting. The ROM 600 need not be mounted outside the controller 100 but may be mounted on the controller 100. The controller 100 equipped with the ROM 600 may be, for example, the above-described MCU.

A hardware configuration of the inverter 300 will be described in detail with reference to FIG. 2.

FIG. 2 schematically shows the hardware configuration of the inverter 300 of the motor controlling system 1000 according to the present example embodiment.

The inverter 300 includes three low side switching elements and three high side switching elements. As shown, switching elements SW_L1, SW_L2, and SW_L3 are the low side switching elements, and switching elements SW_H1, SW_H2, and SW_H3 are the high side switching elements. For example, a semiconductor switching element such as a field effect transistor (FET, typically a metal-oxide semiconductor field-effect transistor (MOSFET)) or an insulated gate bipolar transistor (IGBT) may be used as the switching element. The switching element includes a reflux diode configured to allow a regenerative current flowing toward the motor M to flow therefrom.

FIG. 2 shows shunt resistors Rs of two current sensors 400A and 400B configured to detect currents flowing in the U-phase and the V-phase. As shown, for example, the shunt resistor Rs may be electrically connected between the low side switching element and a ground. Alternatively, for example, the shunt resistor Rs may be electrically connected between the high side switching element and a power source.

For example, the controller 100 may drive the motor M by performing a control through three-phase conduction (hereinafter, referred to as a “three-phase conduction control”) based on a vector control. For example, the controller 100 generates a PWM signal for performing a three-phase conduction control and outputs the PWM signal to the driving circuit 200. The driving circuit 200 generates a gate control signal for controlling a switching operation of each FET of the inverter 300 based on the PWM signal and supplies the generated gate control signal to a gate of each FET.

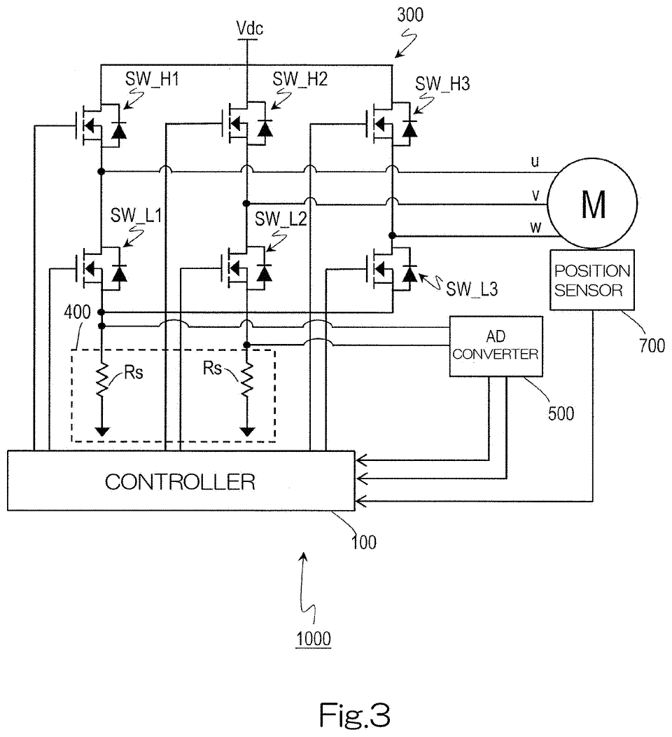

FIG. 3 schematically shows a hardware block of a motor controlling system 1000 according to a modified example of the present example embodiment.

As shown in the drawing, the motor controlling system 1000 may not include a driving circuit 200. In this case, a controller 100 includes a port capable of directly controlling a switching operation of each FET of an inverter 300. Specifically, the controller 100 may generate a gate control signal based on a PWM signal. The controller 100 may output the gate control signal through the port and supply the gate control signal to a gate of each FET.

As shown in FIG. 3, the motor controlling system 1000 may further include a position sensor 700. The position sensor 700 is disposed in a motor M, detects a rotor angle, and outputs the detected rotor angle to the controller 100. The position sensor 700 is implemented, for example, by a combination of a magnetoresistive (MR) sensor including an MR element and a sensor magnet. The position sensor 700 is implemented by using, for example, a Hall integrated circuit (IC) including a Hall element or a resolver.

The motor controlling system 1000 may include, for example, a speed sensor or an acceleration sensor instead of the position sensor 700. When the speed sensor is used as the position sensor, the controller 100 may calculate a rotor angle, i.e., a rotation angle, by performing integral treatment or the like on a rotational speed signal or an angular speed signal. An angular speed is expressed in radians per second (rad/s) at which a rotor rotates for one second. In addition, when the acceleration sensor is used as the position sensor, the controller 100 may calculate a rotation angle by performing integral treatment or the like on an angular acceleration signal.

The motor controlling system of the present disclosure may be used, for example, as a motor controlling system for performing a sensorless control, which does not include a position sensor as shown in FIGS. 1 and 2. In addition, the motor controlling system of the present disclosure may be used, for example, as a motor controlling system for performing a sensor control which includes a position sensor as shown in FIG. 3.

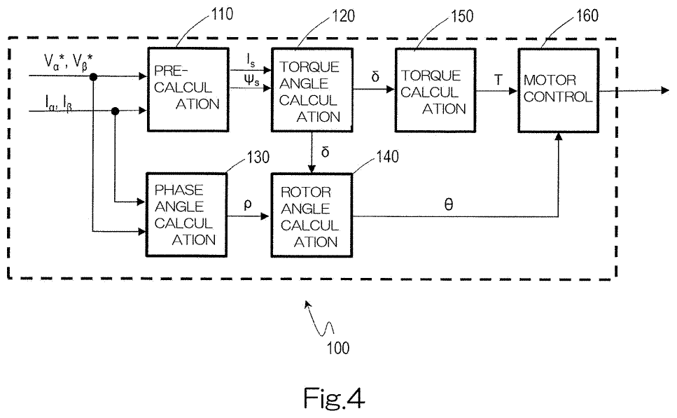

Hereinafter, by exemplifying a motor controlling system for controlling a sensorless control, a specific example of a motor controlling method used in the system will be described with reference to FIGS. 4 to 7, and calculations used to estimate a torque angle will be mainly described. The motor controlling method of the present disclosure may be used in various motor controlling systems for controlling an SPM motor in which a torque angle estimation is required.

An outline of a controlling method of a motor controlling system 1000 is as follows.

First, three-phase currents Iₐ, I_{b}, and I_{c} measured by a current sensor 400 are transformed into a current Iα and a current I_{β} on an α-axis and a β-axis of anαβ fixed coordinate system. Next, a phase angle ρ is calculated based on the current I_{α} and the current I_{β}. In addition, In addition, a stator current Iₛ and a resultant magnetic flux ψₛ are calculated. After that, a torque angle δ is estimated based on the stator current Iₛ, and the resultant magnetic flux ψₛ. In addition, torque T and a rotor angle θ required for controlling a motor are determined based on the torque angle δ. Finally, a motor M is controlled based on the torque T and the rotor angle θ.

An algorithm for implementing the motor controlling method according to the present example embodiment may be implemented, for example, only by hardware such as an application specific integrated circuit (ASIC) or an FPGA or may also be implemented by a combination of hardware and software.

FIG. 4 schematically shows a functional block of a controller 100 for estimating a torque angle δ. In the present specification, each block in a functional block diagram is shown in a functional block unit rather than a hardware unit. A motor control software may be, for example, a module constituting a computer program for executing specific processing corresponding to each functional block. Such a computer program is stored, for example, in a ROM 600.

As shown in FIG. 4, the controller 100 includes, for example, a pre-calculation unit 110, a torque angle calculation unit 120, a phase angle calculation unit 130, a rotor angle calculation unit 140, a torque calculation unit 150, and a motor control unit 160. The controller 100 may calculate a torque angle δ based on a stator current Iₛ and a resultant magnetic flux ψₛ. In the present specification, for convenience of description, each functional block will be expressed as a unit. Of course, the Equation is not intended to be used to limit each functional block to hardware or software.

When each functional block is implemented in the controller 100 as software, an execution subject of the software may be, for example, a core of the controller 100. As described above, the controller 100 may be implemented as an FPGA. In this case, all or some of the functional blocks may be implemented in hardware.

Processing may be distributed using a plurality of FPGAs, and thus, it is possible to distribute a calculation load of a specific computer. In this case, all or some of the functional blocks shown in FIG. 4 may be distributed and mounted in the plurality of FPGAs. For example, the plurality of FPGAs are connected through a control area network (CAN) for a vehicle so as to be able to communicate with each other, and thus, transmission/reception of data is performed.

For example, in a three-phase conduction control, the sum of currents flowing in respective phases ideally becomes zero. In the present specification, a current flowing in a U-phase coil of a motor M is denoted by Iₐ, a current flowing in a V-phase coil of the motor M is denoted by I_{b}, and a current flowing in a W-phase coil of the motor M is denoted by I_{c}. The sum of the currents Iₐ, I_{b}, and I_{c} is zero.

The controller 100 (for example, a CPU core) receives two currents among the currents Iₐ, I_{b}, and I_{c} and obtains the remaining one current through a calculation. In the present example embodiment, the controller 100 obtains the current Iₐ measured by a current sensor 400A and the current I_{b} measured by a current sensor 400B. The controller 100 calculates the current I_{c} based on the currents Iₐ and I_{b} using such a relationship in which the sum of the currents Iₐ, I_{b}, and I_{c} is zero. The currents Iₐ, I_{b}, and I_{c} may be measured using three current sensors and may be input to the controller 100 through an AD converter 500.

The controller 100 may transform the current Iₐ, the current I_{b}, and the current I_{c} into a current I_{α} on an α-axis and a current I^{β} on a β-axis of anαβ fixed coordinate system using a so-called Clarke transform used for a vector control and the like. Here, the αβ fixed coordinate system is a stationary coordinate system. Among three phases, a direction of one phase (for example, the direction of a U-phase) corresponds to the α-axis, and a direction orthogonal to the α-axis corresponds to the β-axis.

In addition, the controller 100 transforms reference voltages Vₐ*, V_{b}*, and V_{c}* into a reference voltage V_{α}* on the α-axis and a reference voltage V_{β}* on the β-axis of the αβ fixed coordinate system using the Clark transformation. The reference voltages Vₐ*, V_{b}*, and V_{c}* indicate the above-described PWM signal for controlling each switching element of an inverter 300.

For example, calculations for obtaining I_{α} and I_{β} and the reference voltages V_{α}* and V_{β}* may also be performed by the motor control unit 160 of the controller 100. The currents I_{α} and I_{β} and the reference voltages V_{α}* and V_{β}* are input to the pre-calculation unit 110 and the phase angle calculation unit 130.

In a motor control according to the present example embodiment, the stator current Iₛ, the resultant magnetic flux ψₛ, and the phase angle ϕ are given as variables, and armature resistance R (mΩ), armature inductance L (μH), and a rotor magnetic flux ψm (Wb) are given as parameters. Here, the rotor magnetic flux ψₘ indicates a magnitude of a magnetic flux of a permanent magnet of a rotor.

The pre-calculation unit 110 obtains the variables Iₛ and ψₛ based on the currents I_{α} and I_{β} and the reference voltages V_{δ}* and V_{β}* with respect to the αβ fixed coordinate system or dq rotating coordinate system. Since the pre-calculation unit 110 delivers the variables to the torque angle calculation unit 120 in rear thereof, the pre-calculation unit 110 is a unit configured to perform a pre-calculation.

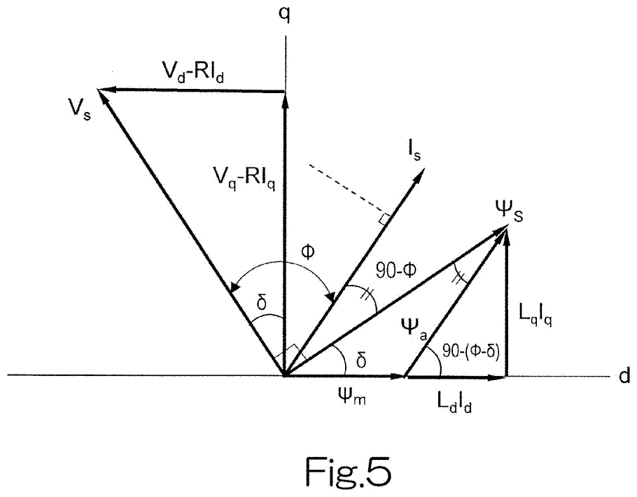

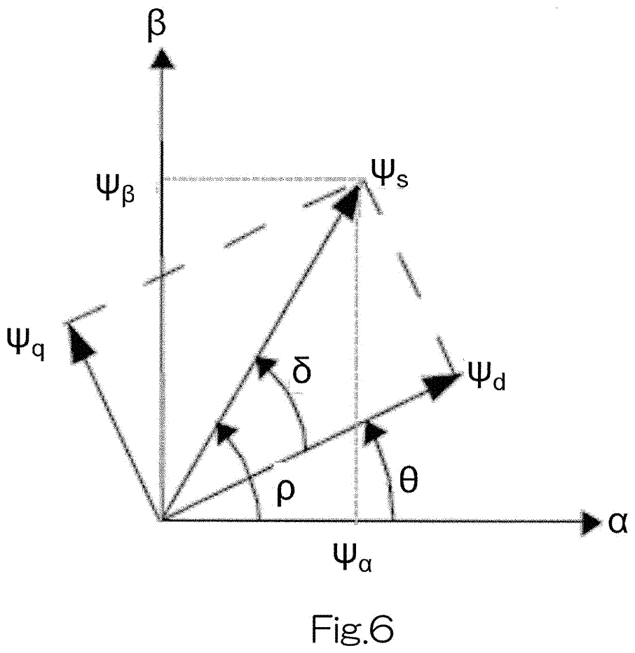

FIG. 5 is a phasor diagram showing variables Iₛ, ψₛ, ϕ, and Vₛ. FIG. 6 is a phasor diagram showing a resultant magnetic flux ψₛ on an αβ fixed coordinate system or dq rotating coordinate system. All of the shown variables are represented by a phasor. Hereinafter, each variable is treated as a phasor.

The pre-calculation unit 110 calculates a stator current Is in a phasor diagram according to Equation 1.

Iₛ=(I_{α}²+I_{β}²)^{1/2} Equation 1

The pre-calculation unit 110 calculates a resultant magnetic flux ψₛ in a phasor diagram based on the currents I_{α} and I_{β} and reference voltages V_{α}* and V_{β}*. Specifically, the pre-calculation unit 110 calculates the resultant magnetic flux ψₛ according to Equations 2 to 4. As shown in FIG. 5, the resultant magnetic flux ψₛ is obtained by adding an armature magnetic flux ψa (=L·Iₛ) to a rotor magnetic flux ψₘ.

For example, the pre-calculation unit 110 calculates a component ψ_{α} on an α-axis of the resultant magnetic flux ψₛ according to Equation 2. The pre-calculation unit 110 calculates a component ψ_{β} on a β-axis of the resultant magnetic flux ψₛ according to Equation 3. Here, LPF in Equations 2 and 3 means processing by a low pass filter. For the purpose of removing harmonics, for example, a general low pass filter of the controller 100 may be used. The resultant magnetic flux ψₛ is represented by Equation 4.

ψ_{α}=LPF (V_{α}*−R·I_{α}) Equation 2

ψ_{β}=LPF (V_{β}*−R·I_{β}) Equation 3

ψₛ=(ψ_{α}²+ψ_{β}²)^{1/2} Equation 4

The pre-calculation unit 110 outputs the variables Iₛ and ψₛ to the torque angle calculation unit 120. Other hardware (for example, an FPGA) different from the controller 100 may calculate the variables Iₛ and ψₛ. The torque angle calculation unit 120 may receive and obtain the variables Iₛ and ψₛ from other hardware. According to such a configuration, a calculation load of the controller 100 may be reduced.

The torque angle calculation unit 120 calculates a torque angle δ based on the parameters L and ψₘ and the variables Iₛ and ψₛ. In FIG. 6, for example, the torque angle δ is expressed as an angle between the resultant magnetic flux ψₛ and a d-axis in the dq rotating coordinate system and is an angle in which a counterclockwise direction is a positive direction.

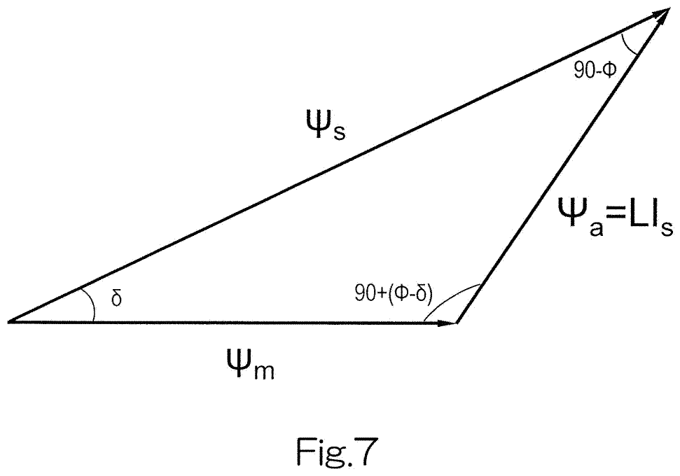

FIG. 7 is a phasor diagram showing a rotor magnetic flux ψₘ, an armature magnetic flux ψₐ, and a resultant magnetic flux ψₛ.

As shown, Equation 5 is obtained by applying a so-called cosine law to a triangle having three sides of ψₘ, ψₐ, and ψₛ Equation 5 is transformed to obtain Equation 6. An inverse trigonometric function of cos(δ) is calculated to obtain Equation 7 with respect to δ. Equation 8 with respect to δ is finally obtained by substituting ψₐ=L·Iₛ into Equation 7.

ψₐ²=ψₛ²+ψₘ²−2ψₛψₘ cos(δ) Equation 5

cos(δ)=(ψₛ²+ψₘ²−ψₐ²)/(2ψₛψₘ) Equation 6

δ=cos⁻¹[(ψₛ²+ψₘ²−ψₐ²)/(2ψₛψₘ)] Equation 7

δ=cos⁻¹[(ψₛ²+ψₘ²−(LIₛ)²)/(2ψₛψₘ)] Equation 8

The torque angle calculation unit 120 outputs the torque angle δ to the torque calculation unit 150 and the rotor angle calculation unit 140. As shown in Equation 8, the variables in the dq rotating coordinate system and the phase angle ϕ are not required for estimating the torque angle δ. As shown in FIG. 5, for example, the phase angle ϕ is expressed as an angle between the stator current Iₛ and the stator voltage Vₛ in the dq rotating coordinate system and is an angle in which a counterclockwise direction is a positive direction. The stator voltage Vₛ is a voltage corresponding to a back electromotive force voltage. As described above, the back electromotive force voltage is referred to as the stator voltage in the present specification. According to the present example embodiment, the torque angle δ may be calculated based on the parameters L and ψₘ and the variables Iₛ and ψₛ.

A phase angle calculation unit 130 estimates a phase angle ρ based on the currents I_{α} and I_{β} and the reference voltages V_{α}* and V_{β}*. As in the pre-calculation unit, the phase angle calculation unit 130 calculates, for example, magnetic flux components ψ_{α} and ψ_{β} according to Equations 2 and 3. In addition, the phase angle calculation unit 130 calculates, for example, the phase angle ρ according to Equation 9. For example, as shown in FIG. 6, the phase angle ρ is expressed as an angle between the resultant magnetic flux ψₛ and the α-axis in the αβ fixed coordinate system and is an angle in which a counterclockwise direction is a positive direction. The phase angle calculation unit 130 outputs the phase angle ρ to the rotor angle calculation unit 140.

ρ=tan¹(ψ_{β}/ψ_{α}) Equation 9

The rotor angle calculation unit 140 calculates a rotor angle θ based on the torque angle δ and the phase angle ρ. A relationship between the torque angle δ, the phase angle ρ, and the rotor angle θ is as shown in FIG. 6. The rotor angle calculation unit 140 may calculate and estimate the rotor angle θ according to Equation 10.

θ=ρ−δ Equation 10

The torque calculation unit 150 calculates torque T based on the torque angle δ. When an SPM motor is used, a saliency ratio (Ld/Lq) becomes 1 (that is, L=Ld=Lq). In this case, it is known that the torque T as a reaction of torque acting on an armature is represented by Equation 11. For example, the torque calculation unit 150 may calculate the torque T based on Equation 11.

T=3/2·P·(ψₘ·ψₛ/L)sin(δ) Equation 11,

wherein P is a parameter indicating the number of motor pole pairs.

The motor control unit 160 may control the motor M based on the torque T and the rotor angle θ. For example, the motor control unit 160 performs a calculation required for a general vector control. Since the vector control is well-known technology, detailed descriptions of the control will be omitted.

According to the present example embodiment, in the sensorless control, a torque angle may be obtained without depending on variables in the dq rotating coordinate system. In addition, since a complicated calculation is not particularly required for estimating the torque angle, it is possible to reduce load of a computer and reduce memory costs.

The validity of the calculation of the torque angle δ according to the present disclosure was verified using a “rapid control prototyping (RCP) system” of dSPACE Company and Matlab/Simulink of MathWorks Company. Verification results are shown below. A model of an SPM motor controlled by a vector control was used for the verification. Values of various system parameters at the time of verification are shown in Table 1.

TABLE 1

| Inertia moment | 6.9e⁻⁵[kg · m²] |
|---|---|
| Friction coefficient | 5.1e⁻³[Nm/(rad/s)] |
| Resistance (motor + ECU) | 8.50 mΩ + 5.43 mΩ |
| L_{d} (nominal) | 40.7 μH |
| L_{q} (nominal) | 38.8 μH |
| Voltage range | 10 to 16 V |
| Temperature range | −40 to 90° C. |
| Motor type | DC brushless motor |
| Number of poles | 8 |
| Number of slots | 12 |
| Maximum current | 77 A |
| Rated voltage | 13.5 V |
| Rated temperature | 80° C. |
| Maximum torque | 5.96 N · m |
| Diameter of coil | Φ 1.45 mm |
| Number of turns | 11.5 |

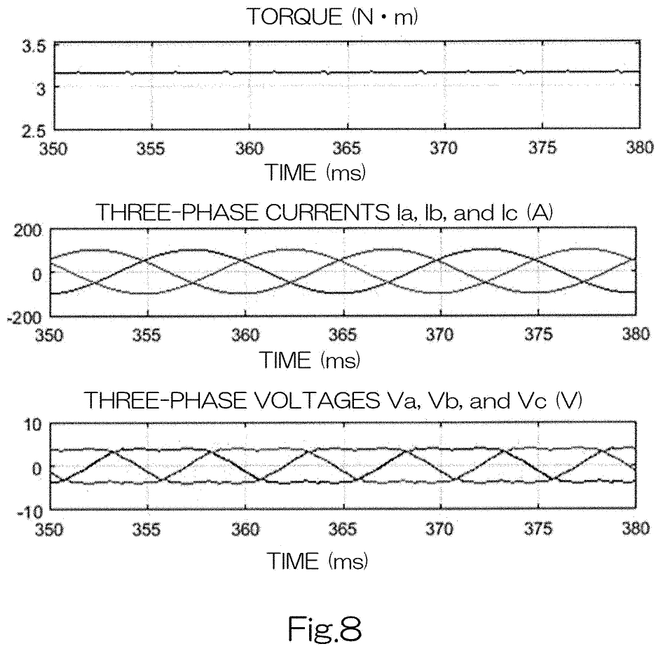

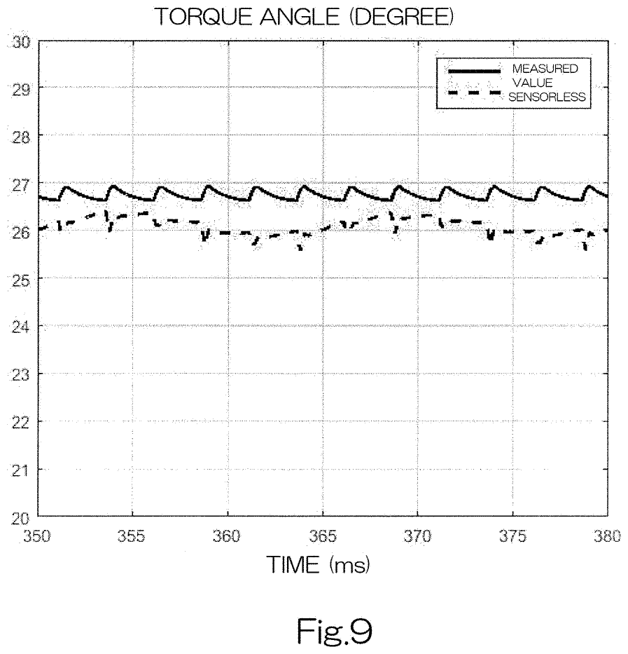

FIG. 8 shows a waveform of torque (top), waveforms of three-phase currents (middle), and waveforms of three-phase voltages (bottom) within a certain period (for 0.03 seconds from 0.35 seconds to 0.38 seconds). FIG. 9 shows a waveform of a torque angle (degree) estimated using a calculation equation of the present disclosure and a measured value of a torque angle within a certain period. A horizontal axis of FIGS. 8 and 9 represents a time (ms). A vertical axis of FIG. 8 represents a magnitude (N·m) of torque, a current value (mA), and a voltage value (V) in order from an upper side of FIG. 8. A vertical axis of FIG. 9 represents a size (degree) of a torque angle.

It can be seen from a simulation result of FIG. 8 that a vector control is properly performed. It can be seen from a simulation result of FIG. 9 that the estimated torque angle δ using the calculation equation of the present disclosure is similar to the measured value. More specifically, an error between the estimated torque angle δ and the measured value is about one degree. In a sensorless control, an allowable value of an error thereof is generally about ten degrees. The error obtained from the simulation results is a value sufficiently satisfying a range of an allowable value.

From the simulation results, it can be seen that a torque angle is precisely estimated in the sensorless control by using a method of calculating a torque angle proposed in the present specification.

The present disclosure is not limited to the sensorless control as described above, but the method of estimating the torque angle δ according to the present disclosure may also be suitably used for the motor controlling system for controlling a sensor shown in FIG. 3.

The controller 100 of the motor controlling system 1000 shown in FIG. 3 may calculate the torque angle δ based on the variables in the dq rotating coordinate system. For example, the controller 100 may calculate the torque angle δ according to Equation 12 (see FIG. 5).

δ=tan⁻¹[(V_{d}−R·I_{d})/(V_{q}−R·I_{q})] Equation 12

Here, V_{d} is a voltage component of an armature voltage on a d-axis, and V_{q} is a voltage component of the armature voltage on a q-axis. I_{d} is a current component of an armature current on the d-axis, and I_{q} is a current component of the armature current on the q-axis.

In a sensor control, when a position sensor is broken due to any cause, a rotor angle may not be measured. Therefore, it is difficult to continue the sensor control. On the other hand, when the position sensor fails, it is possible to switch a motor control from the sensor control to the sensorless control. Even when the position sensor fails, the motor control may be continued by applying the method of estimating the torque angle according to the present disclosure to the sensorless control.

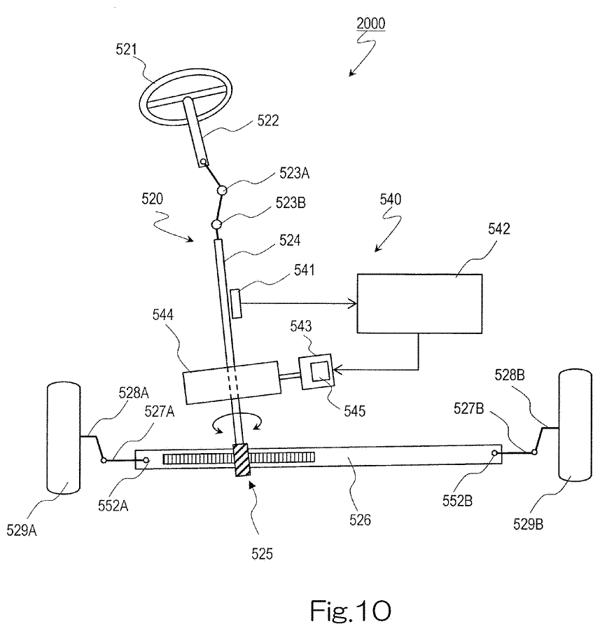

FIG. 10 is a schematic diagram illustrating a typical configuration of an electric power steering (EPS) system 2000 according to the present example embodiment.

A vehicle, such as a car, generally includes an EPS system. The EPS system 2000 according to the present example embodiment includes a steering system 520 and an auxiliary torque mechanism 540 configured to generate an auxiliary torque. The EPS system 2000 generates an auxiliary torque that assists in a steering torque of the steering system generated by a driver operating a steering wheel. Operation load of the driver is reduced by the auxiliary torque.

For example, the steering system 520 includes a steering wheel 521, a steering shaft 522, universal shaft joints 523A and 523B, a rotation shaft 524, a rack and pinion mechanism 525, a rack shaft 526, left and right ball joints 552A and 552B, tie rods 527A and 527B, knuckles 528A and 528B, and left and right steering wheels 529A and 529B.

For example, the auxiliary torque mechanism 540 includes a steering torque sensor 541, an electronic control unit (ECU) 542 for a vehicle, a motor 543, and a deceleration mechanism 544. The steering torque sensor 541 detects steering torque in the steering system 520. The ECU 542 generates a drive signal based on a detection signal of the steering torque sensor 541. The motor 543 generates an auxiliary torque according to steering torque based on the drive signal. The motor 543 transfers the generated assist torque to the steering system 520 through the deceleration mechanism 544.

For example, the ECU 542 includes the controller 100 and the driving circuit 200 according to example Embodiment 1. In a car, an electronic control system is built based on the ECU. In the EPS system 2000, for example, a motor controlling system is built by the ECU 542, the motor 543, and the inverter 545. The motor controlling system 1000 according to example Embodiment 1 may be suitably used as the motor controlling system.

The example embodiments of the present disclosure are suitably used in an X-by-wire system such as a shift-by-wire system, a steer-by-wire system, or a brake-by-wire system, and a motor controlling system of a traction motor or the like, in which an ability to estimate a torque is required. For example, the motor controlling system according to the example embodiments of the present disclosure may be mounted on an autonomous vehicle corresponding to Levels 0 to 4 (standard of automation) defined by the Japanese government and the National Highway and Traffic Safety Administration (NHTSA) of the U.S. Department of Transportation.

According to example embodiments of the present disclosure, provided are a novel motor controlling method capable of estimating a torque angle without depending on variables in a dq rotating coordinate system in a sensorless control, a motor controlling system, and an electronic power steering system including the motor controlling system.

The example embodiments of the present disclosure may be widely used in various apparatuses including various motors such as a vacuum cleaner, a dryer, a ceiling fan, a washing machine, a refrigerator, and an electronic power steering system.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-5. (canceled)

6. A motor controlling method of controlling a surface permanent magnet motor, the motor controlling method comprising:
a step of obtaining a resultant magnetic flux and a stator current, which are represented by a phasor, with respect to an αβ fixed coordinate system or a dq rotating coordinate system;
a step of calculating a torque angle (δ) according to:
δ=cos⁻¹[(ψₛ²+ψₘ²−(LIₛ)²)/(2ψₛψₘ)],
where L is an armature inductance, ψₘ indicates a magnetic flux of a stator magnet, ψₛ indicates a magnitude of the resultant magnetic flux, and Iₛ indicates a magnitude of the stator current; and
a step of controlling the surface permanent magnet motor based on the torque angle (δ).

7. The motor controlling method of claim 6, further comprising a step of calculating torque (T) based on the torque angle (δ); wherein
in the step of controlling the surface permanent magnet motor, the surface permanent magnet motor is controlled based on the torque (T).

8. The motor controlling method of claim 7, further comprising a step of calculating a phase angle (ρ) based on components of the resultant magnetic flux on an α-axis and a β-axis in the αβ fixed coordinate system and calculating a rotor angle (θ) based on the torque angle (δ) and the phase angle (ρ); wherein
in the step of controlling the surface permanent magnet motor, the surface permanent magnet motor is controlled based on the rotor angle (θ) and the torque (T).

9. A motor controlling system comprising:
a surface permanent magnet motor; and
a control circuit to control the surface permanent magnet motor; wherein
the control circuit obtains a resultant magnetic flux and a stator current, which are represented by a phasor, with respect to an αβ fixed coordinate or a dq rotating coordinate system,
calculates a torque angle (δ) according to:
δ=cos⁻¹[(ψₛ²+ψₘ²−(LIₛ)²)/(2ψₛψₘ)],
where L is an armature inductance ψₘ indicates a magnetic flux of a stator magnet, ψₛ indicates a magnitude of the resultant magnetic flux, and Iₛ indicates a magnitude of the stator current, and
controls the surface permanent magnet motor based on the torque angle (δ).

10. An electronic power steering system comprising the motor controlling system of claim 9.
